(19) United States
(12) Patent Application Publication
(10) Pub. No.: US 2003/0231345 A1
(43) Pub. Date: Dec. 18, 2003

(54) Printer, printing method, medium recording data generation management program, print control device, print control method, medium recording print control program, and print system

(75) Inventor: Osamu Azami, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/391,461

(22) Filed: Mar. 19, 2003

(30) Foreign Application Priority Data
Mar. 20, 2002 (JP) 2002-78775
Mar. 27, 2002 (JP) 2002-89342

(51) Int. Cl. G06F 15/00; G06K 1/00; B41J 1/00

(52) U.S. Cl. 358/1.18; 358/1.16

(57) ABSTRACT

The conventional practice of storing the related information data of format pattern in the hard disk of a computer and storing the image of format pattern in a laser printer has the disadvantage that the one-to-one correspondence between the related information data and the image data is lost if the hard disk of the computer is formatted.

This disadvantage is eliminated by registering and storing for unitary control the image data 30b1 of the format pattern, which is superposed over the document 20a1 generated by the computer 20, and the related information data 30b2 in the laser printer 30. In this way it is possible for the printer 20 to use the image data 30b1 stored in the laser printer 30 by reading out the related information data 30b2 from the laser printer 30 even when the hard disk of the computer 20 is formatted or the computer 20 is replaced by another computer 20.

### BACKGROUND OF THE INVENTION

1. Field of the Invention

The present invention relates to a printer, a printing method, a medium recording a data generation management program, a print control device, a print control method, a medium recording a print control program, and a print system.

2. Description of the Prior Art

The conventional printing system constructed of a computer and a laser printer works in such a way that once a format pattern to be superposed over print data is generated by an application installed in a computer, the printer drive generates information data relating to this format pattern and stores it on the hard disk attached to the computer. The thus generated data for a format pattern is transferred to the laser printer, in which it is converted into printable image data, which is then stored in an internal hard disk. At the time of overlay printing, the computer displays this related information data, so that the user selects the format pattern to be supposed and indicates it to the print data. Upon reception of this print data, the laser printer reads out the image data corresponding to the specified format pattern and performs printing, with the print data superposed.

It is necessary that the related information data and the image data be stored such that they keep a one-to-one correspondence. The conventional printing system meeting this requirement stores the related information data in the computer and stores the image data in the printer. The disadvantage of this practice is that the one-to-one correspondence is lost when the hard disk in the computer or the printer is formatted or the printer is connected to a computer of different type. A problem in this case is that the related information data exists but the image data is missing or the related information data remains but the image data has disappeared.

### SUMMARY OF THE INVENTION

The present invention was completed to tackle the above-mentioned problem or to keep consistency between the related information data and the image data of format pattern.

According to the present invention, the above-mentioned object is achieved by a printer to produce a printed matter in which print data is superposed over image data of format pattern, said print data being generated by data produced by execution of an application of the connected computer, said printer having image data and related information data stored therein. The print data and image data are entered into the connected computer through an input unit. The generating unit generates the related information data regarding the image data on the basis of the image data entered through the input unit. At the same time, the storing unit stores the image data and the related information data thus generated, while keeping their mutual correspondence. The related information data is necessary when the image data is superposed over the print data by the computer. Therefore, the output unit outputs to the computer the related information data, which has been stored, in compliance with the demand from the computer. In this way the computer is able to display the related information data. The printing unit produces a printed matter in which the stored image data is superposed over the print data thus entered. In other words, the printer stores the related information data and the image data while keeping their mutual correspondence and supplies them to the computer at an adequate time, so that the computer is able to perform superposed printing while keeping good consistency between the related information data and the image-data.

As explained above, the present invention permits the image of format pattern and the related information data to keep consistency between them.

The data of a format pattern, which is based on the data format produced by execution of an application of the computer, is stored in a printer such that it corresponds to the image data stored in the printer and it can be read from the computer. In this way the computer is able to read the data by using its application and produce the image data.

Alternatively, the storing unit of the printer stores the data of a format pattern, which is produced by execution of an application of the computer, such that the computer can read the thus stored data. In this way the computer is able to read and compile the data of a format pattern, which is stored in the printer, by using its application.

If the printer stores an application capable of generating a format pattern, then it is not necessary for the computer to have such an application. Thus, another embodiment of the present invention may be such that the printer stores in its storing unit an application capable of generating a form pattern in such a way that the computer can read such an application. The advantage of this embodiment is that all that is necessary for the computer to generate the data of format pattern is to read an appropriate application and the data of format pattern from the printer. There is no need to install purposely the application in the computer. The result is that the computer can generate a format pattern as it reads the application and the data of format pattern from the printer connected thereto regardless whether or not the application is installed in the computer.

The outputting unit is provided with a start signal inputting unit which inputs the start signal, which is output when the computer is turned on, to the outputting unit, and when this start signal inputting unit inputs the start signal, the outputting unit outputs to the computer the related information data stored in the storing unit.

Alternatively, the outputting unit is provided with a demand signal inputting unit which inputs the signal to demand the related information data, which is output when the computer generates the print data, to the outputting unit, and when this demand signal inputting unit inputs the signal to demand the related information data, the outputting unit outputs to the computer the related information data stored in the storing unit.

The generating unit may generate, based on the image data entered as the related information data, data to display the image data in reduced size. According to a preferred embodiment of the present invention, the computer displays an image of the image data in reduced size; however, it is not always necessary that the computer display an image of the image data in reduced size. The image data to be displayed may be draft data or bitmap data.

The generating unit may also generate, based on the image data entered as the related information data, the attribute information data of the image data. This attribute information data, which is generated by the image data, may be acceptable so long as it shows the attribute of the image data. It includes such data as paper feed direction, resolution, paper size, file name, originator of the image data, etc.

The connected computer may output the demand to acquire the related information data and acquire the related information data when the printing data is generated or when the related information data is generated by the generating unit. The way in which the computer acquires the related information data as it is generated makes it possible for the computer to acquire the latest related information data every time when it is generated and renewed. When the generating unit generates the related information data, it informs the computer of the generation of the related information data. And the thus informed computer may acquire the generated/renewed related information data.

Informing the computer of the generation and renewal of the related information data permits the computer to acquire the renewed latest related information data.

Printing of a printed matter in which print data (which is generated on the basis of the data generated by execution of a prescribed application of the connected computer) is superposed over image data of format pattern does not always need a tangible apparatus installed in the printer to store the related information data of the image data. Such printing may be accomplished by using an adequate method. Thus the present invention is embodied in an apparatus as well as a method.

Incidentally, the printer mentioned above may be used alone or may be installed in a certain machine. Thus, the present invention covers various embodiments which manifest themselves as software or hardware. Such software may exist on a recording medium in which it is stored.

Such a recording medium may be a magnetic recording medium or a magneto-optical recording medium. It also includes any recording medium which would be developed in the future. The software may be a primary copy or a secondary copy. The present invention remains unchanged in its scope even though it is embodied in a combination of software and hardware. The software may be used in such a way that part of it is stored on the recording medium and it is read as needed.

The above-mentioned printer permits one to generate and control the related information data of the image of a format pattern. For this reason, the present invention may be embodied in a print controller which acquires and displays the related information data stored in the printer when the computer (connected to the printer) performs printing for the print data and image data which are supposed one over the other.

According to another embodiment of the present invention, the print controller may be connected to the printer (which generates the prescribed related information data of the image of format pattern) so that it acquires the related information data of the image of format pattern to be superposed over the generated print data, from the printer and displays it. In this case, the generating unit generates the print data based on the data generated by a prescribed application. The generating unit also generates the image data of format pattern to be printed in superposition on the print data by a prescribed application. At this time, the output unit outputs the generated image data to the printer and causes the printer to generate and store therein the related information data of the image data. When the display unit displays the related information data, the acquisition demand output unit outputs to the connected printer a demand to acquire the related information data which has been generated and stored by the printer, and the storing unit stores the thus acquired related information data. Here, the display unit displays the thus stored related information data. In other words, the printer integrally stores and controls the related information data and the image data, so that the print controller only needs to display the related information data which has been read from the printer, when it generates the image data. Thus it is possible to keep a one-to-one correspondence between the related information data and the image data even though another print controller is connected to the printer.

It is desirable if the latest related information data can be acquired every time the related information data is generated and renewed by the printer. This may be achieved if the acquisition demand output unit informs of the renewal of the related information data which has been output from the connected computer. When the acquisition demand output unit enters this information, it outputs to the printer the demand to acquire the related information data.

The print controller mentioned above is not necessarily limited to a tangible one. Its function may also be achieved by an appropriate method. Therefore, the print control apparatus may be in the form of software or hardware. If the print control apparatus is in the form of software, such software is recorded on a recording medium.

It is desirable if the above-mentioned printer exists as part of the printing system to be used in the network environment. Such a printing system may consist of a printer (which has the same function as the above-mentioned printer), a computer (which has the same function as the print controller), and a server, which are connected to one another through a network capable of communication between them. The server in the present invention is provided with a server-side generating unit to generate the image of format pattern on the basis of data generated by execution of a prescribed application and an image data output unit to output the thus generated image data to the printer. Each client is provided with a print data generating unit to generate print data based on the data generated by execution of a prescribed application, a print data output unit to output the thus generated print data to the printer, and a related information data acquisition unit to acquire the prescribed related information data about the image data to be superposed over the print data. In this way the server can generate and control the image data of format pattern. This facilitates the control of image data.

The data of format pattern, which is generated by execution of an application, may be stored in the related information data storing unit such that it can be read from the computer. In this way the server can read the data of format pattern stored in the printer and compile it by using an application. Also, the related information data storing unit may store an application capable of generating the data of format pattern such that it can be read from the server. In this way the application in the server can read the data of format pattern stored in the printer and compile it adequately. Upon connection to the printer, the server can generate the format pattern regardless of whether or not the application is installed in the server.

Now, there is a practical printer which is provided with a storage unit (such as hard disk) in which the print job is registered.

Any printer which permits the print jot to be registered stores the registration order in the storage unit after adding identification information to print data relating to the registration order after it has received the registration order of the print job from the computer connected to the printer through a network or the like. When the printer receives a print instruction for the registered print job, it reads out the print data stored in the storage unit and performs printing.

If the user registers in the printer the print job relating to documents which are frequently printed, then printing is possible without the print data being sent from the computer to the printer. This offers the advantage that it is possible to save time necessary to call the document and order printing on the computer each time printing is performed and hence it is possible to perform printing from any computer on the network.

Any printer that stores the print job can usually permit registration of more than one print job. Therefore, any print system provided with such a printer displays a list of the print jobs registered therein, so that the user can select from the list one specific print job for printing. In other words, the printer has the function to prepare a list for display and sends it back to the computer when it receives a demand for displaying a list of the print jobs.

FIG. 22 is a list for display which is conventionally prepared by the printer. The list represents the information of print jobs (such as document name and the date and time of registration) in the text mode. Such a list poses a problem with poor legibility.

For the user to easily grasp the content of the registered print jobs, it is desirable to display the print image in the reduced thumbnail mode. However, the control of thumbnails has never been accomplished by the printer itself. For this reason it was necessary to use a separate printer for the server in order to achieve the thumbnail display. This results in a large-scale print system.

It is another object of the present invention to provide a print system provided with a printer capable of registration of print jobs, said print system displaying in the thumbnail mode a list of the print jobs registered in the printer without using the print server.

The invention to achieve this object is embodied in a printer of the type having an image data generating unit to generate image data based on the print data, a printing unit to perform printing based on the thus generated image data, and a storage device, wherein said printer comprises a print data storage unit to store the print data in said storage device, a thumbnail generating unit to generate thumbnails, for the print data to be stored in said storage device, based on the image data generated by said image data generating unit and stores the thumbnails in said storage device, and a thumbnail display unit to generate a display of a thumbnail list with reference to the thumbnails stored in said storage device.

The printer may further comprise a printing unit for the registered print data which works in such a way that when a particular thumbnail is specified in the display of a thumbnail list, the print data corresponding to this thumbnail is extracted from said storage device and printing is performed based on the thus extracted print data.

The image data generating unit can generate the image data in the units of band based on the print data. In this case, the thumbnail generating unit divides the image data in the units of band into a plurality of blocks and generates the thumbnails by processing the blocks one by one. The block should have a size (corresponding to the band width) which can divide the band width.

In the case where the print data consists of more than one page, the thumbnail generating unit mentioned above generates thumbnails for all the pages or generates the thumbnail for the first page according to the user's specification.

In addition, the print data to be registered in the storage device may contain the print data relating to library.

The present invention to tackle the above-mentioned problem is also embodied in a print system of the type having a print control device to output print data, an image generating unit to generate image data based on the print data received from said print control device, and a printer provided with a printing unit to perform printing based on the thus generated image data and a storage device, wherein said printer has a print data storage unit to store print data in said storage device, a thumbnail generating unit which, for print data stored in said storage device, generates thumbnails based on the image data generated by said image data generating unit and stores them in said storage device, and a thumbnail display unit which generates a list of thumbnails with reference to the thumbnails stored in said storage device and outputs it to said print controller, and said print controller displays the list of thumbnails received from said printer.

The advantage of this embodiment is that the print system provided with a printer capable of registering print jobs can display With thumbnails a list of print jobs registered in the printer without having to use the print server.

### BRIEF DESCRIPTION OF THE DRAWINGS

FIG. 1 is a diagram showing the printer and print controller pertaining to the present invention.

FIG. 2 is a diagram showing an appearance of a print system consisting of a computer (as a print controller) and a laser printer (as a printer).

FIG. 3 is a schematic diagram showing the internal structure and data flow in the print system consisting of a computer and a laser printer.

FIG. 4 is a diagram showing a composition of a display used to define a format pattern.

FIG. 5 is a flow chart showing the process for data generation and control.

FIG. 6 is a flow chart showing the process for display.

FIG. 7 is a flow chart showing the other process for display.

FIG. 8 is a flow chart showing the other process for data generation and control.

FIG. 9 is a flow chart showing the other process for display.

FIG. 10 is a schematic diagram showing the internal structure of the print system (as a modified embodiment) consisting of a computer and a laser printer and also showing the data flow in the print system.

FIG. 11 is a flow chart showing the process for editing.

FIG. 12 is a schematic diagram showing the internal structure of the print system (as the second embodiment) including a server and also showing the data flow in the print system.

FIG. 13 is a block diagram of a network print system to which the present invention is applied.

FIG. 14 is a block diagram of a printer in the network print system.

FIG. 15 is a block diagram showing how the printer is constructed of various components.

FIG. 16 is a diagram showing the data flow in the printer (from the reception of a print command from a computer through a network to the execution of printing).

FIG. 17 is a diagram showing the data flow in the printer (from the reception of a print job registration command from a computer through a network to the generation of print job thumbnails).

FIG. 18 is a diagram showing the data flow in the printer (from the reception of a library registration command from a computer through a network to the registration of library and the generation of library thumbnails).

FIG. 19 is a diagram showing the data flow in the printer (from the reception of a command for display of thumbnails of registered print jobs from a computer through a network to the display of thumbnails on a computer screen).

FIG. 20 is a diagram showing the data flow in the printer (from the reception of print jobs specified in a list of thumbnails to the execution of printing).

FIG. 21 is a diagram showing a list of thumbnails of registered print jobs.

FIG. 22 is a diagram showing a list of print jobs which is prepared by a conventional printer.

### DESCRIPTION OF THE PREFERRED EMBODIMENTS

The embodiments of the present invention will be described in the following order.

(1) Outline of the present invention

(2) Outline of the function of the first embodiment

(3) Process for data generation and control

(4) Content of display process

(5) Content of display

(6) Outline of the function of a modified embodiment

(7) Content of editing process

(8) Outline of the function of the second embodiment

(9) Summary of the first and second embodiments

(10) Outline of the construction of the third embodiment

(11) Outline of the function of the third embodiment (regarding the first process)

(12) Outline of the function of the third embodiment (regarding the second process)

(13) Outline of the function of the third embodiment (regarding the third process)

(14) Outline of the function of the third embodiment (regarding the fourth process)

(15) Outline of the function of the third embodiment (regarding the fifth process)

(1) Outline of the Present Invention

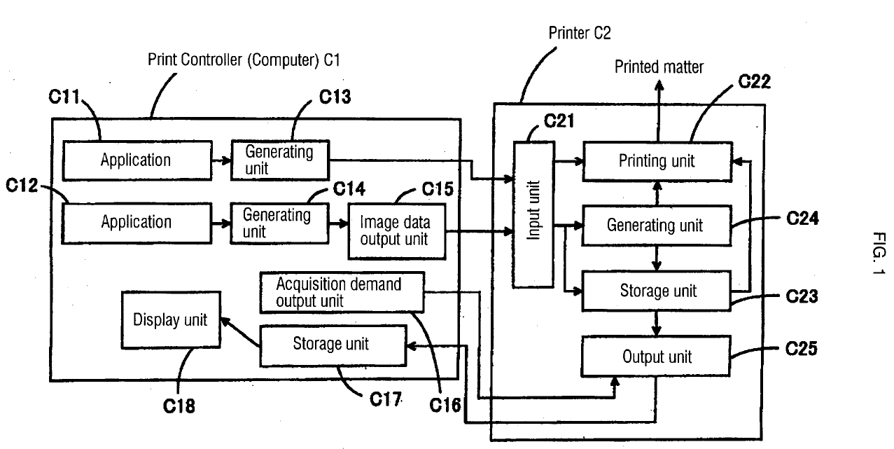

FIG. 1 is a diagram showing the printer and print controller pertaining to the present invention.

In FIG. 1, there are shown a print controller C1 (a computer) and a printer C2 (a laser printer) which are connected to each other for two-way communication. The print controller C1 has applications C11 and C12 installed therein which work under a prescribed operating system. The application C11 generates documents and graphics. The user employs this application C1 to prepare desired documents and graphics. When the application C11 generates documents and graphics and they are printed, the generating unit C13 generates print data based on data representing the documents and graphics. The print data is sent to the printer C2, which receives it through the input unit C21.

The print data thus entered is used for printing by the printing unit C22. According to this embodiment, printing is done in such a way that a prescribed format pattern (such as frame and confidential mark) is superposed over the documents and graphics prepared by the application C11 in the print controller C1. The application C12 in the print controller C1 is capable of generating such a format pattern. The thus generated format pattern is converted into image data by the generating unit C14 and the resulting image data is sent to the printer C2 through the image data output unit C15. The printer C2 enters the image data of format pattern into the input unit C21 and, at the same time, stores it in the storage unit C23. In this case, the generating unit C24 generates the related information data of the image data entered through the input unit C21. The thus generated related information data is stored in the storage unit C23 in such a way as to keep correspondence between them.

Thus, the image data for a format pattern and the related information data are stored in the printer C2, such that one-to-one correspondence is kept between them. At the time of superposition of a format pattern over the documents and graphics prepared by the application C11 in the print controller C1, the related information data stored in the storage unit C23 in the printer C2 is referenced and the image data to be superposed according to the related information data is selected. At this point, the print controller C1 sends a command to acquire the related information data to the printer C2 by means of the acquisition demand output unit C16. The printer C2 receives this acquisition demand by means of the output unit C25, and the output unit C25 reads the related information data from the storage unit C23 and sends it to the print controller C1. The print controller C1 stores the related information data (sent from the print controller C1) in the storage unit C17 and displays it by means of the display unit C18. The user selects the image data to be superposed by referencing the related information data displayed on this display unit C18. When selected, it adds the selected data to the print data and sends to the printer C2. At this point, the printing unit C22 acquires the specified image data from the storage unit 23 and performs printing by superposing it over the print data.

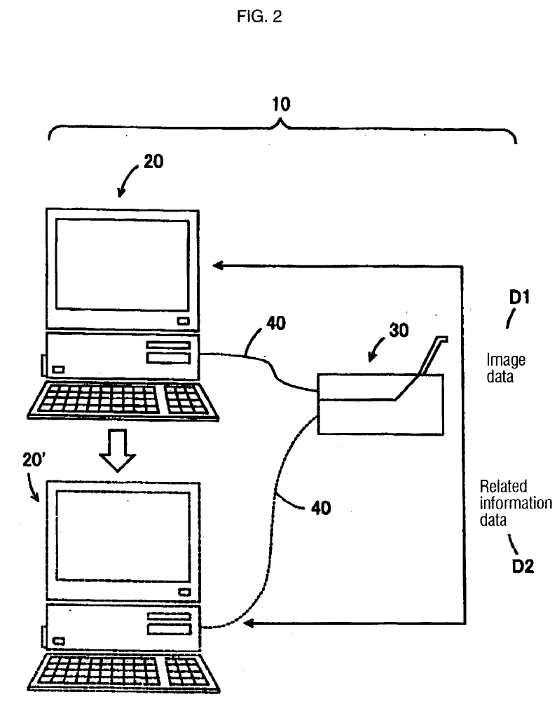

FIG. 2 is a diagram showing an appearance of a print system consisting of a computer (as the print controller C1) and a laser printer (as the printer C2). In this figure, the print system 10 consists of a computer 20 and a laser printer 30. The computer 20 and the laser printer 30 are connected to each other through the interface 40 that permits two-way communications. This communication interface may be a USB interface or a parallel interface so long as it permits two-way communications. The laser printer 30 has a hard disk (not shown) in which are registered and stored the image data D1 of format pattern and the related information data D2 showing the attributes and thumbnails of the image data D1. The computer 20 prepares a document and graphic and a format pattern and superposes the format pattern over the document and graphic. At this point, the computer 20 acquires the related information data D2 from the laser printer 30 and displays a prescribed image on a CRT.

Based on the related information data D2 which has been displayed, the user of the computer 20 selects the image data D1 to be superposed. Data to specify the selected image data D1 is added to the print data when the print data is sent to the laser printer 30. According to this instruction, the laser printer 30 reads the image data D1 from the hard disk and superposes it on the print data. The fact that the image data D1 and the related information data D2 are stored altogether in the laser printer 30 offers the advantage that when the computer 20 connected to the laser printer 30 is replaced by a new computer 20′, the user of the new computer 20′ can utilize the image data D1 and the related information data D2 stored in the laser printer 30.

(2) Outline of the Function of the First Embodiment

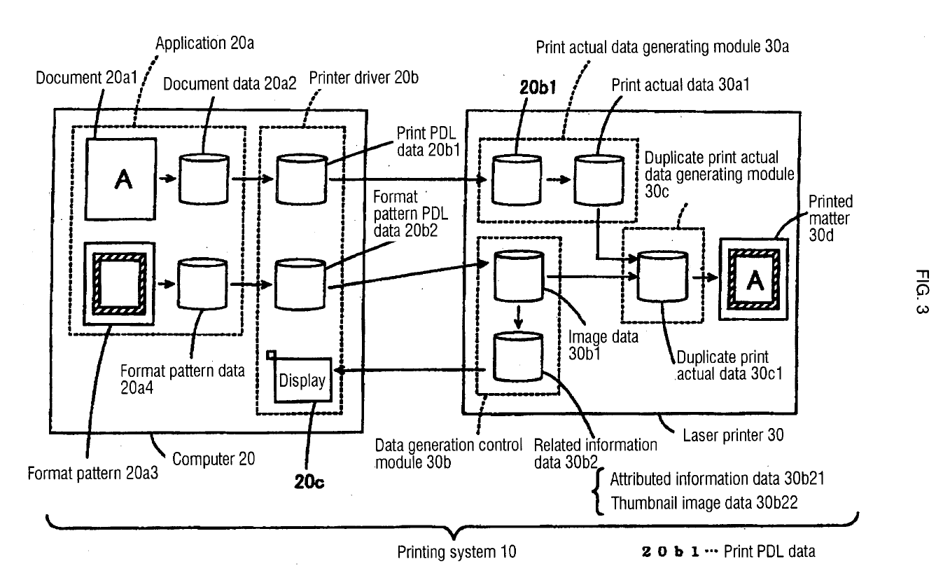

FIG. 3 is a schematic diagram showing the internal structure and data flow in the print system 10 consisting of the computer 10 and the laser printer 20.

In this figure, as mentioned above, the print system 10 consists of the computer 20 and the laser printer 30 which are connected together through the communication interface 40 that permits two-way communications. The computer 20 works under control of a prescribed operating system. This operating system permits software (such as application 20a and printer driver 20b) to function properly. The application 20a prepares the document 20a1 (having a character “A”) to be printed and generates the document data 20a2. In addition, it stores them in a storage region (not shown) and prepares the format pattern 20a3 to be superposed over the document 20a1 and generates the format pattern data 20a4.

Once the document data 20a2 and the format pattern data 20a4 have been generated, they are entered into the printer driver 20b when the former is printed and the latter is transferred. The printer driver 20b has a module to convert the data 20a2 and 20a4 into PDL data, so that this module converts the data 20a2 and 20a4 into PDL data. At this time, the document data 20a2 is converted into the print PDL data 20b1 and the format pattern data 20a4 is converted into the image PDL data 20b2. The thus converted print PDL data 20b1 and image PDL data 20b2 are sent to the laser printer 30.

On the other hand, the laser printer 30 has several modules therein, which realize the printed matter 30d in which a format pattern is superposed over a document. In this case, the print actual data generating module 30a enters the document PDL data 20b1 which has been output from the computer 20. It interprets the PDL data and generates the print actual data 30a1 (developed into a bit map). The laser printer 30 enters the image PDL data 20b2 (which has been output from the computer 20) into the data generation control module 30b. It interprets the PDL data and generates the image data 30b1 (developed into a bit map). This image data 30b1 is registered as the format pattern and stored in a hard disk (not shown). The duplicate print actual data generating module 30c generates the duplicate print actual data 30c1 in which the image data 30b1 is superposed over the print actual data 30a1. It also prints the duplicate print actual data 30c1 by means of a print engine (not shown), thereby producing the printed matter 30d in which a format pattern (like a frame) is superposed over the document having a character “A”.

In the above-mentioned construction, the laser printer 30 causes the data generation control module 30b to generate the image data 30b1, thereby performing the data generation control (mentioned later). In this way the laser printer 30 generates the related information data 30b2 of the image data 30b1 (composed of the attribute information data 30b21 and the thumbnail image data 30b22) and stores it in a hard disk (not shown) installed therein. When the user of the computer 20 prepares the document and graphic by using the application 20a and performs printing in which a prescribed format pattern is superposed, the display module 20c possessed by the printer driver 20b executes the display process (mentioned later) and outputs the read command of the related information data 30b2 to the laser printer 30. Then, this read command is received by the above-mentioned data generation control process, and the related information data 30b2 stored in the hard disk is sent to the computer 20. The display module 20c enters this related information data 30b and makes a display based on the related information data 30b2. Then the user selects, based on this display, the format pattern to be superposed.

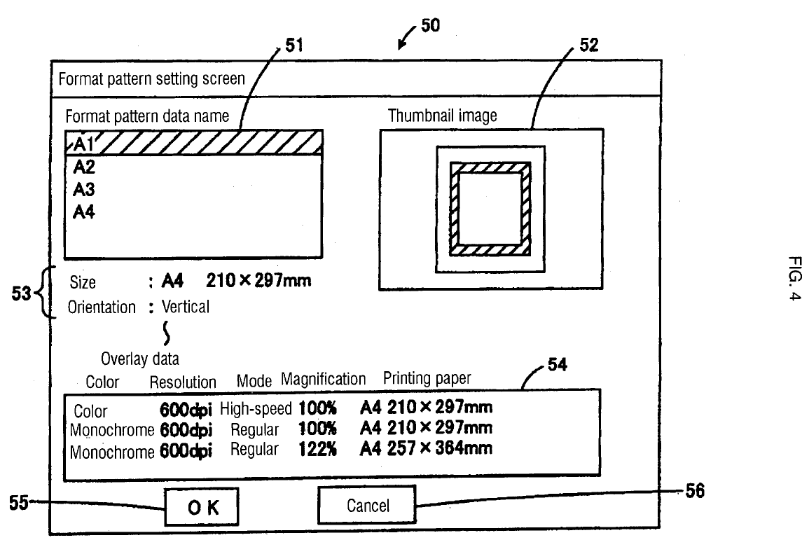

FIG. 4 is a diagram showing a composition of a display used to define a format pattern. This display is one example which is based-on the related information data 30b2. In this figure, the format pattern setting screen 50 is composed of a format pattern data name section 51, a thumbnail image 52, a print paper information section 53, and an overlay data information section 54. The format pattern data name section 51 contains a list of data names of the image data 30b1 registered and stored in the hard disk of the laser printer 30. The user selects any one of the data name by using an input unit such as a mouse. The thumbnail image 52 shows the thumbnail image of the image data 30b1 selected in the format pattern data name section 51.

Thus, the user selects the image data 30b1 to be superposed from the format pattern data name section 51 while watching the thumbnail image displayed on the thumbnail image 52. The print paper information section 53 contains print paper information about the print paper that permits printing of the selected image data 30b1, such as paper size and printing direction. The overlay data information section 54 contains the print setting to be used when the image data 30b1 is superposed. Therefore, the user selects prescribed data in this overlay information section 54 so as to print the image data 30b1. After this selection, the user presses the OK button 55. This step confirms the selection. If the user does not want to superpose the format pattern, the user presses the cancel button 56 to close the format pattern setting screen 50.

With the help of the format pattern setting screen 50 composed as mentioned above, the user selects the format pattern to be superposed over the document and graphic prepared by using the application 20a, while confirming the content of the related information data 30b2 stored in the laser printer 30. The data relating to the thus selected format pattern is added to the print PDL data 20b1 and then sent to the laser printer 30. Upon reception of the print PDL data 20b1, the laser printer 30 searches the registered image data 30b1 according to the added data relating to the format pattern and reads the searched image data 30b1 from the hard disk. Finally, the duplicate print actual data generating module 30c generates the duplicate print actual data 30c1 in which the image data 30b1 is superposed over the print actual data 30a1, and printing is carried out to produce the printed matter 30d.

(3) Process for Data Generation and Control

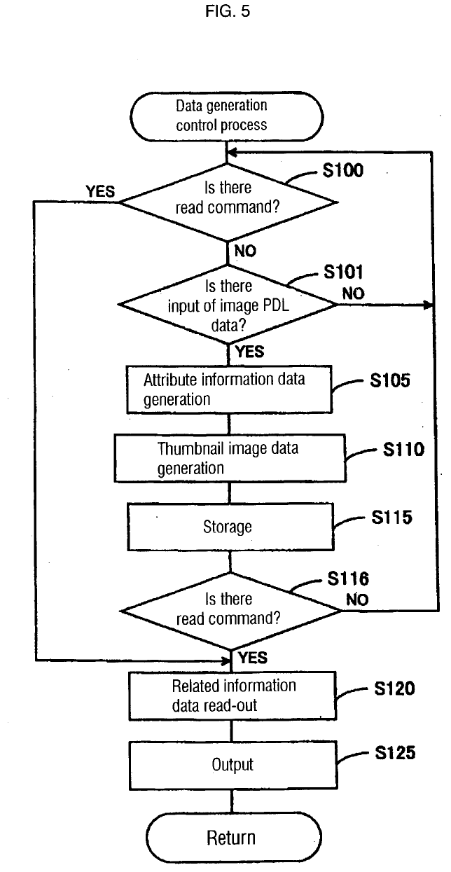

FIG. 5 is a flow chart showing the process for data generation and control which is carried out by the data generation control module 30b mentioned above.

In this process, the module judges whether or not there is an input for command to read the related information data 30b2 to be output from the printer driver 20b of the computer 20 (Step S100). If there is no input for read command, the module judges whether or not the image PDL data 10b2 has been entered into the data generation control module 30b from the printer driver 20b of the computer 20 (Step S101).

Then, if there is an input of the image PDL data 20b2, the module generates the attribute information data 30b21 (as the related information data 30b2 ) based on the image PDL data 20b2 thus entered (Step S105). Subsequently, the module generates the thumbnail image data 30b22 (Step S110) and stores the thus generated related information data 30b2 in a prescribed region in the hard disk (Step S115). The module judges again whether or not there is an input for command to read the related information data 30b2 to be output from the printer driver 20b of the computer 20 (Step S116). If there is no input for read command, the process returns to Step S100. If the module judges (in Step S100 and Step S116) that there is an input for read command, then the module reads related information data 20b2 from the hard disk (Step S120) and sends it to the computer 20 (Step S125).

(4) Content of Display Process

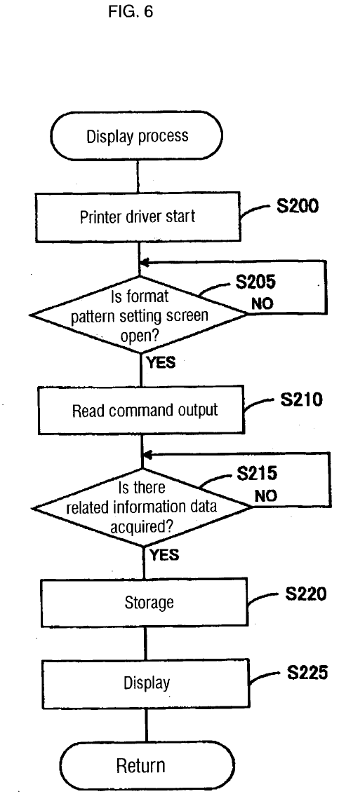

FIG. 6 is a flow chart showing the process for display to be executed by the display module 20c of the printer driver 20b.

In this process, as soon as the printer driver 20b is started (Step S200), the module judges whether or not the format pattern setting screen 50 (capable of display) has been opened by the printer driver 20b (Step S205). If the format pattern setting screen 50 has been opened, the module sends the read command to the laser printer 30 (Step S210). According to this read command, the module acquires the related information data 30b2 which has been output from the data generation control module 30b of the laser printer 30 (Step S215) and stores it in the hard disk (Step S220). As soon as the module stores the related information data 30b2 in the hard disk, it reads the related information data 30b2 (which has been stored) and displays it on the format pattern setting screen 50 (Step S225).

In the above-mentioned display process, the module outputs the read command to the laser printer 30 when the printer driver 20b opens the format pattern setting screen 50, thereby acquiring the related information data 30b2 and displaying the format pattern setting screen 50. Timing to acquire the related information data 30b2 is not limited to timing to open the format pattern setting screen 50; but it may be timing to turn on the computer 20.

(5) Content of Display

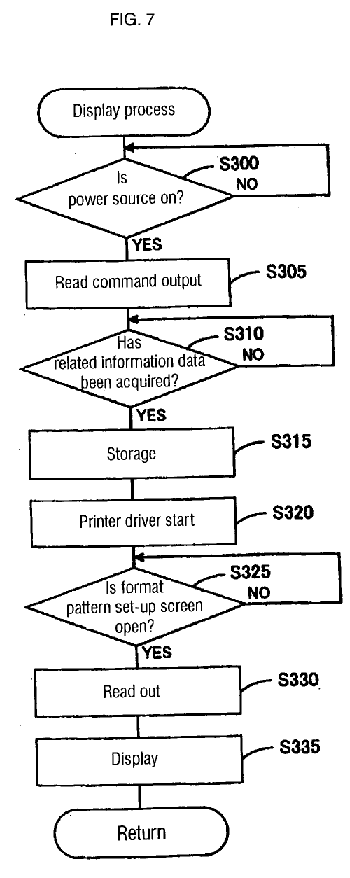

FIG. 7 is a flow chart showing the other process for display in which the related information data 30ba is acquired when the computer 20 is turned on.

In this process, the module judges whether or not prescribed notification (which is output first when the computer 20 is turned on) has been entered (Step S300). If such notification has been entered, the module sends the above-mentioned read command to the laser printer 30 (Step S305). The module receives the related information data 30b2 which is output from the data generation control module 30b of the laser printer 30 according to this read command (Step S310) and stores it in an appropriate region of the hard disk in the computer 20 (Step S315). As soon as the printer driver 20b is started (Step S320), it judges whether or not the format pattern setting screen 50 (which is capable of display) has been opened (Step S325). If it judges that the format pattern setting screen 50 has been opened, it reads out the related information data 30b2 stored in an appropriate region of the above-mentioned hard disk (Step S330) and displays it on the format pattern setting screen 50 (Step S335).

In the above-mentioned display process, the module outputs the read command from the computer 20 when the printer driver 20b in the computer 20 is started or when the computer 20 is turned on, and then it acquires the related information data 30b2 which has been output from the data generation control module 30b in the laser printer 30 and stores it in an appropriate region of the hard disk in the computer 20. In other words, the read command is output to the laser printer 30 according to the prescribed action in the computer 20. When to output the read command from the computer 20 to the laser printer 30 is not limited to the time which depends on the action of the computer 20. The timing may depend on the action of the laser printer 30. In such a case, for example, the process may be modified such that when the laser printer 30 renews the related information data 30b2, it notifies the computer 20 of this change and the read command is output according to this notification.

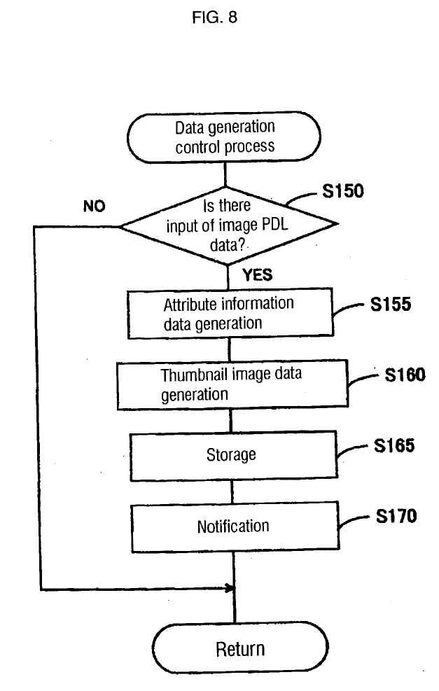

FIG. 8 is a flow chart showing another example of the process for data generation and control which is carried out by the data generation control module 30b. In this process, the module first judges whether or not the image PDL data 20b2 has been entered into the data generation control module 30b from the printer driver 20b of the computer 20 (Step S150). If the image PDL data 20b2 has been entered, the module generates the attribute information data 30b21 (as the related information data 30b2) (Step S155) and generates the thumbnail image data 30b22 (Step S160) according to the image PDL data 20b2 thus entered, and then it stores the related information data 30b2 thus generated in an appropriate region of the hard disk, thereby renewing the related information data 30b2 (Step S165). At this point, the module sends a signal to inform the computer 20 that the related information data 30b2 stored in the hard disk has been renewed (Step S170). Upon reception of this signal, the computer 20 sends a read command to the laser printer 30 in order to acquire the latest version of the related information data.

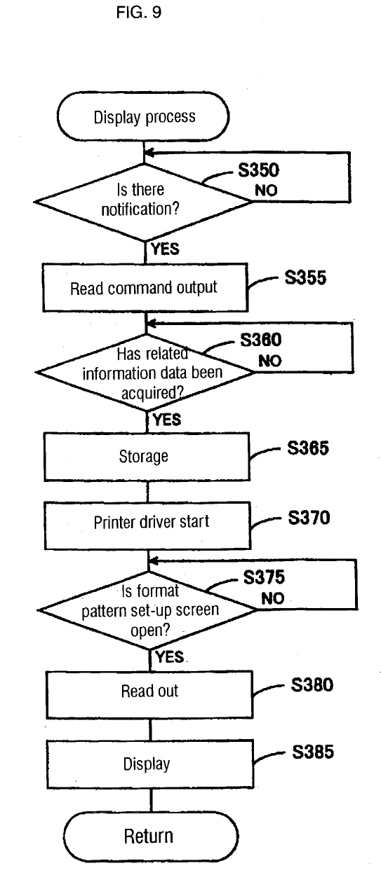

FIG. 9 is a flow chart showing one example of the process for display which is implemented when the computer 20 acquires the related information data 30b2 in response to the data generation control process which notifies of the renewal of the related information data 30b2. In this process, the module first judges whether or not a notification of the renewal of the related information data 30b2 has been received from the laser printer 30 (Step S350). If a notification of renewal has been received, the module sends a command to read the related information data 30b2 to the laser printer 30 (Step S355). Then, according to this read command, the module acquires the related information data 30b2 sent from the data generation control module 30b of the laser printer 30 (Step S360) and stores it in an appropriate region of the hard disk in the computer 20 (Step S365). At this point, the printer driver 20b is started (Step S37), then the printer driver 50 judges whether or not the format pattern setting screen 50 (ready for display) is open (Step S375). If it judges that the format pattern setting screen 50 has been opened, it reads out the related information data 30b2 stored in an appropriate region in the hard disk (Step S380) and displays it on the format pattern setting screen 50 (Step S385).

The above-mentioned embodiment is carried out in such a way that the laser printer 30 registers the format pattern 20a3 (generated by the computer 20) as the image data 30b1, and the data generation control module 30b generates its related information data 30b2 and stores it, while keeping correspondence with the image data 30b1, in the hard disk in the laser printer 30. The laser printer 30 sends the related information data 30b2 to the computer 20 for display in answer to the read command from the computer 20. The fact that the laser printer stores and controls the image data 30b1 and the related information data 30b2 offers the advantage that it is possible to save the image data 30b1 and the related information data 30b2 while keeping their one-to-one correspondence even though the hard disk of the computer 20 is formatted by mistake.

(6) Outline of the Function of a Modified Embodiment

The user installs an application that works on the computer 20 in the hard disk of the laser printer 30 and also stores the format pattern data (corresponding to the image data 30b1 registered in the laser printer 30) which can be read and written by the installed application. Storing the application and the format pattern data in the laser printer 30 permits the computer 20 to read the application and the format pattern data when the format pattern is generated and edited. This obviates the necessity of installing in the computer 20 the application 20a to generate the format pattern. Regardless of installing, the computer 20 can edit the image data 30b1 registered in the laser printer 30 only if it reads out the application and the format pattern data stored in the laser printer 30.

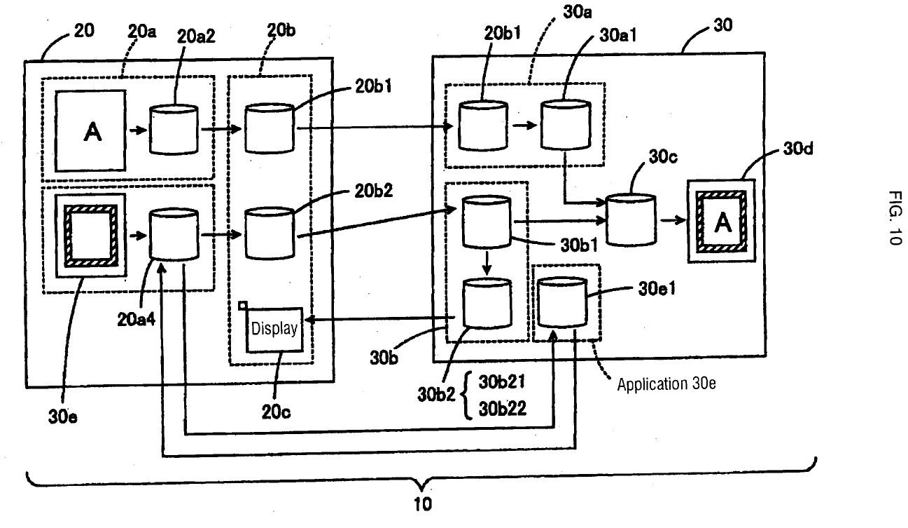

FIG. 10 is a schematic diagram showing the internal structure of the print system 10 (as a modified embodiment) consisting of a computer 20 and a laser printer 30 and also showing the data flow in the print system. In this figure, the computer 20 is constructed in the same way as that shown in FIG. 3. The laser printer 30 is constructed in the same way as that shown in FIG. 3, except that it has an additional hard disk (not shown) storing the application 30e (which works in the same way as the application 20a) and the format pattern data 30e1 which can be read and written by the application 30e. The format pattern data 30e1 corresponds to the image data 30b1 registered and stored in the laser printer 30.

Thus, when the user of the computer 20 generates a format pattern, he reads out the application 30e from the laser printer 30, thereby making the computer 20 operable, and also reads out the format pattern 30e1. In this way it is possible to confirm the content of the image data 30b1 registered in the laser printer 30. The user may edit, by using the application 30e, the format pattern data which has been read out and registers again the edited data (as the image data 30b1) in the laser printer 30. In this way it is possible to maintain and customize the image data 30b1 in the laser printer 30. Here, the format pattern data 30e1 may be stored in the laser printer 30 by the application 30e when the image data 30b1 is output to the laser printer 30.

(7) Content of Editing Process

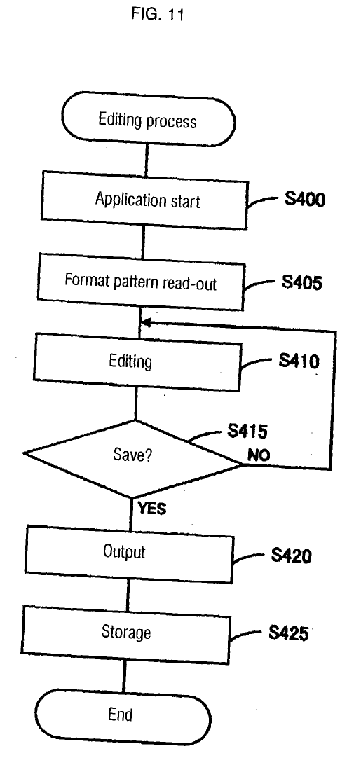

FIG. 11 is a flow chart showing the content of the editing process to be executed by the application 30e which has been read into the computer 20 from the laser printer 30.

In this figure, when the user of the computer 20 confirms and edits the content of the format pattern image data 30b1 registered in the laser printer 30, the application 30e is read from the laser printer 30 to start (Step S400) and then the format pattern data 30e1 is read from the laser printer 30 (Step S405). The user edits the content of the format pattern data 30e1 (which has been read out) by using the application 30e (Step S410). After editing, the user selects “save” (Step S415), then the edited data is converted into the format pattern PDL data 20b2 and sends it to the laser printer 30. At this point, the application 30e sends the format pattern data to the laser printer 30 (Step S420). Then, the format pattern PDL data 20b2 (as the image data 30b1) is stored in the laser printer 30, and the format pattern (which has been output at the same time) is stored as the format pattern data 30e1 in the laser printer 30 (Step S425).

In the above-mentioned first embodiment, the print system 10 is constructed of the computer 20 and the laser printer 30. Storing the format pattern image data 30b1 and the related information data 30b2 in the laser printer 30 makes it possible to realize the unitary control of the image data 30b2 and the related information data 30b2. According to the first embodiment, the user of the computer 20 can register the image data 30b1 of the format pattern in the laser printer 30 and edit it. This is convenient for the user of the computer 20; however, there is a possible inconvenience in controlling the image data 30b1 of the format pattern to be registered in the laser printer 30. In such a case, the computer 20 and the laser printer 30 are connected together through a network (like LAN) and a server is placed in the network. The server is provided with an application to generate the format pattern, so that the administrator of the server can control the registration and editing of the image data 36b1.

(8) Outline of the Function of the Second Embodiment

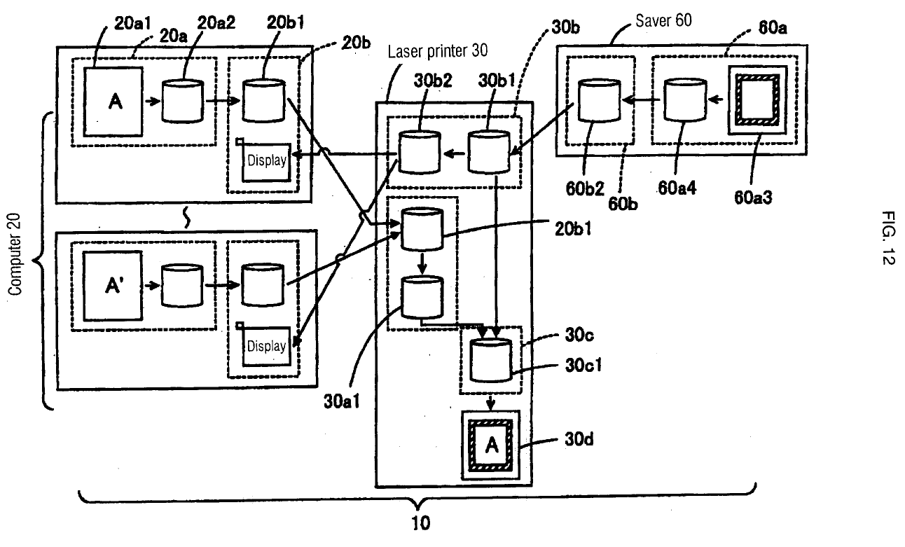

FIG. 12 is a schematic diagram showing the internal structure of the print system (as the second embodiment) including a server (mentioned above) and also showing the data flow in the print system.

In this figure, the print system 10 is constructed of a plurality of computers 20, a laser printer 30, and a server 60, which are connected together through a network interface that permits two-way communications. Each computer 20 is the same as that shown in FIG. 3 except that the application 20a is not capable of generating the format pattern 20a3. The laser printer 30 is the same as that shown in FIG. 3. The server 60a3 has an application 60a which can generate the format pattern 60a3.

The application 60a generates the format pattern data 60a4 based on the format pattern 60a3 which has been produced, and then transfers it to the application 60b capable of conversion into PDL data. The application 60b converts the format pattern data 60a4 into the format pattern PDL data 60b2 and sends it to the laser printer 30. The laser printer 30 generates the image data 30b1 based on the format pattern PDL data 60b2 which has been received, and generates the related information data 30b2 and registers and stores it in a hard disk (not shown). In this way, the administrator can make the server 60 to generate the format pattern 60a3 and register and store it in the laser printer 30. This facilitates the control of the image data 30b1 stored in the laser printer 30.

(9) Summary of the First and Second Embodiments

In the first and second embodiments, the print system 10 consists of the computer 20 and the laser printer 30 such that the computer generates the document 20a1 and the laser printer 30 stores the image data 30b1 and the related information data 30b2 of the format pattern 20a3 to be superposed over the document 20a1. This construction facilitates the unitary data control, so that the computer 20 can use the image data 30b1 stored in the laser printer 30 by reading the related information data 30b2 from the laser printer 30 even in the case where the hard disk in the computer 20 is formatted by mistake or the computer 20 is replaced by another one.

(10) Outline of the Construction of the Third Embodiment

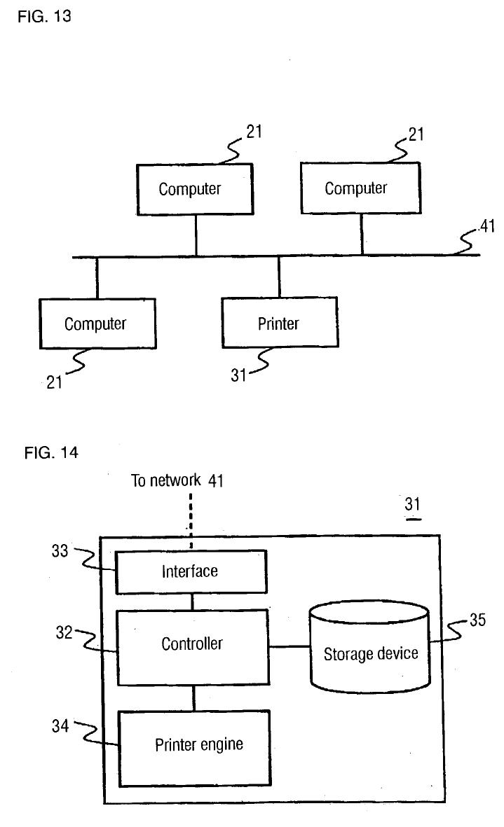

FIG. 13 is a block diagram showing an example of the network print system to which the present invention is applied.

In this figure, the network print system consists of a plurality of printers 21 connected together through the network and a printer 31 which works on the network. The network 41 may typically be a LAN based on the Intranet; it may be a wide area network based on the Internet.

The present invention may be applied to not only the network print system shown in FIG. 13 but also to the print system in which a local printer is connected a single computer.

In FIG. 13, the computer 21 sends the print data to the printer 31, thereby causing the printer 31 to perform printing. The printer 21 also registers the print job or library (such as overlay form) in the printer 31, reads the image (such as print job) registered in the printer 31, and specifies the print job, thereby causing the printer 31 to perform printing. These processes are accomplished by the computer program (such as exclusive software and printer driver) installed in the computer 21.

Incidentally, the computer 21 may be any ordinary personal computer which is provided with devices for display, input, storage, communication, etc. In addition, the computer 21 is provided with Web browser software to read Web pages so that it can handle the print job information registered in the printer 31 by using HTTP (hypertext transfer protocol) as the general-purpose protocol or by using files written in HTML (hypertext markup language). The protocol for information exchange is not limited to HTTP and the file format is not limited to HTML either. The software to read information may be modified according to the protocol and file format.

FIG. 14 is a block diagram illustrating an example of the structure of the printer 31.

As shown in the figure, the printer 31 consists of the controller 32 to control the printer 31, the interface 33 to connect the printer 31 to the network, the print engine 34 having the printing mechanism and paper feeding and discharging mechanism, and the storage device 35 having a hard disk drive.

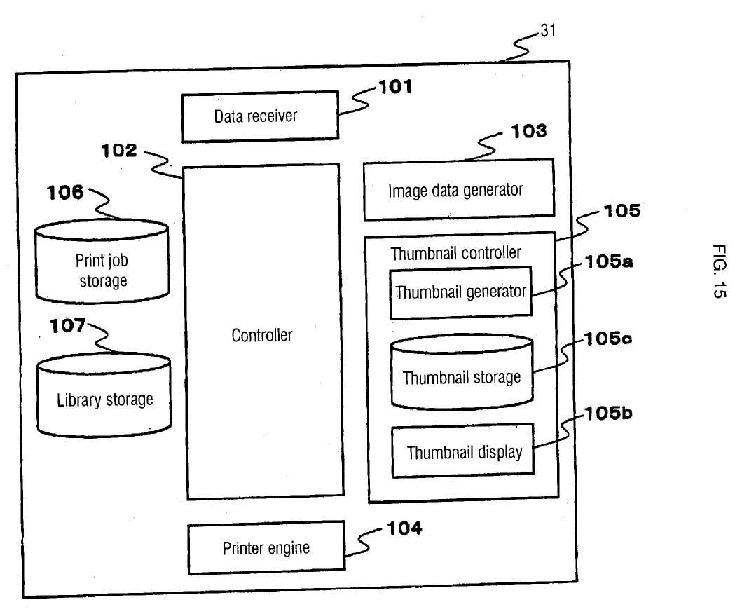

FIG. 15 is a block diagram showing how the printer 31 (shown in FIG. 14) is constructed of various components.

As shown in the figure, the printer 31 is constructed of the data receiver 101, the controller 102, the image data generator 103, the printer engine 104, the thumbnail controller 105, the print job storage 106, and the library storage 107.

The data receiver 101 receives the print command, print job registration command, and print data from the computer 21.

The controller 102 controls various processes by the printer 31 (such as printing process, thumbnail generating process, and thumbnail displaying process) according to the command received from the computer 21. The details of the process will be given later.

The image data generator 103 generates the image data according to the print data received from the computer 21. The print data is a group of commands which express the content of print in a format of functions (such as PDL). The image data is in the data format represented by bit units to be actually printed.

While the image data is being generated according to the print data, the print data is temporarily converted into the index format (called intermediate code) and then developed into the image data.

On account of the limit of memory capacity, the conversion of print data into intermediate code and the development of intermediate code into image data are accomplished by the unit called band. The band is one of regions (say, 64 regions) constituting one page. The advantage of processing by the units of band is that the printer can accomplish printing by the units of page even though it does not have a memory capacity necessary for one page.

The printer engine 104 executes printing based on the image data.

The thumbnail controller 105 controls the thumbnails which display in reduced size the print image of the print job and library registered in the printer 31.

To accomplish this processing, the thumbnail controller 105 has the thumbnail generator 105a, thumbnail display 105b, and thumbnail storage 105c.

The print job storage 106 stores the print job registered in the printer 31.

The library storage 107 stores the library data registered in the printer 31. The library data may be, for example, form data to be used for overlay printing and stamp marks to be printed at a prescribed position in the page.

The thumbnail data is generated in such a way as to establish association among the print job stored in the print job storage 106, the library data stored in the library storage 107, and the thumbnail data of these print data stored in the thumbnail storage 105c.

The printer 31 in this embodiment works in the following manner.

(11) Outline of the Function of the Third Embodiment (Regarding the First Process)

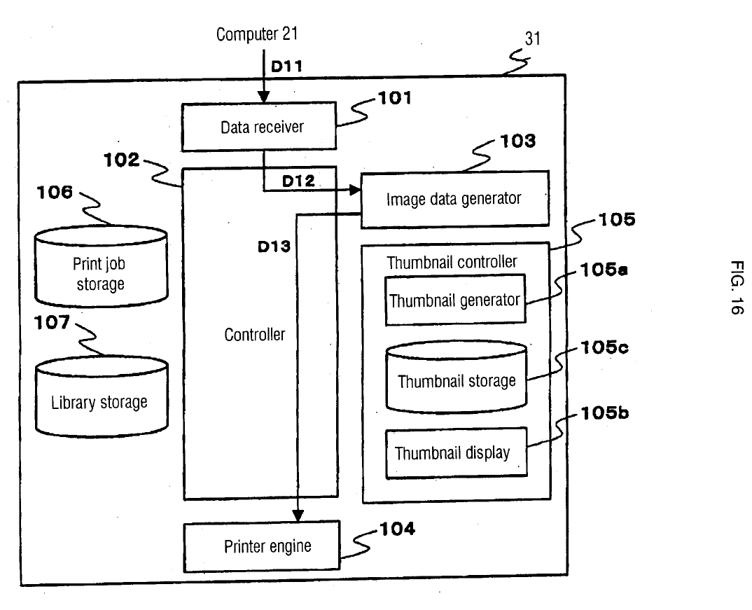

The following explains how printing is accomplished when the printer 31 receives a print command from the computer 21 connected through the network 41. FIG. 16 is a diagram showing the data flow in the ordinary printing process.

First, the data receiver 101 receives a print command and print data relating to the print command from the computer 21 (D11).

The controller 102 sends the print data (received by the data receiver 101) to the image data generator 103 by the units of band. The image data generator 103 generates the image data (based on the print data) by the units of band (D12).

Then, the controller 102 sends the image data to the printer engine 104 by the units of band. As soon as the image data for one page is formed, the printer engine 104 carries out printing (D13).

(12) Outline of the Function of the Third Embodiment (Regarding the Second Process)

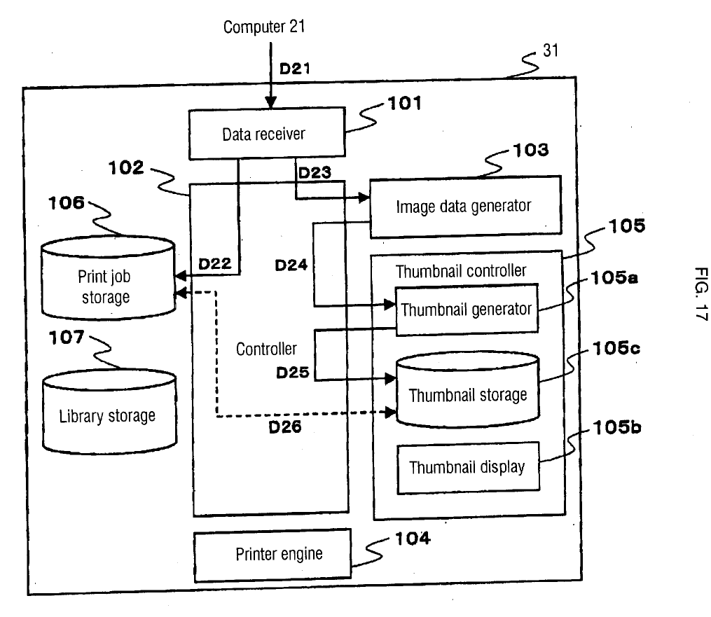

The following explains how the printer 31 registers print jobs and generates thumbnails of print jobs upon reception of print jobs from the computer 21 connected through the network 41. FIG. 17 is a diagram showing the data flow in this occasion.

First, the data receiver 101 receives from the computer 21 a command for registration of print jobs and print data relating to registration (D21).

The controller 102 registers the received print data in the print job storage 106 (D22) and sends the print data to the image data generator 103 by the units of band (D23). The image data generator 103 generates, based on the print data, the image data by the units of band. Incidentally, the format for registration in the print job storage 106 is not limited to the received print data but it may be the image data generated by the image data generator 103 or the format of intermediate code.

Next, the controller 102 sends the image data generated by the image data generator 103 to the thumbnail generator 105a by the units of band (D24).

The thumbnail generator 105a generates the thumbnail based on the image data and registers it in the thumbnail storage 105c (D25). At this point, the thumbnail to be registered is made to correspond to the print data registered in the print job storage 106 (D26). In addition, the thumbnail storage 105c permits the registration of the data and time of registration, paper size, and other information relating to the print job.

In other words, this embodiment works in such a way that upon reception of a command for registration of the print job, the printer 31 stores the print data relating to the command for registration and generates the thumbnail based on the print data and stores it in association with the print data.

In this embodiment, the process for thumbnail generation is accomplished in the following manner. The thumbnail generator 105a generates the thumbnail based on the image data generated by the image data generator 103. At this time, the image data generator 103 generates the image data by the units of band based on the print data by the units of band. The thumbnail generator 105a also generates the thumbnail by the units of band based on the image data by the units of band. For this reason, it is possible to generate the thumbnail without having to secure the memory capacity to store the print data for one page and hence it is possible to reduce the memory capacity necessary to generate the thumbnail.

The thumbnail is generated basically by dividing the bit map image data into several blocks and thinning out bits from each block according to a prescribed rule. The size (the number of bits) of one block divided in the band direction should be any value which divides the number of bits in the band width. In this way it is possible to simplify the processing, without the block extending over more than one band.

The method for generating the thumbnail is not limited to this. Any other known methods may be used.

One of the feature of the present invention is that the thumbnail is generated based on the image data which has been generated in the same way as the ordinary printing process. In other words, it performs the virtual printing process at the time of print job registration, thereby generating the image data for each band, and then generates the thumbnail.

In the case where the print data composed of more than one page, the user may choose any one of two modes. In the first mode, the thumbnails are generated for the entire pages, and in the second mode, the thumbnails are generated for a prescribed page, say, the first page only.

This is realized by displaying a set-up screen which permits the user's selection. Alternatively, the user is prompted to make a selection when the command for registration of the print job is received.

The set-up for registration of thumbnails may be modified such that the user specifies the size of thumbnail, the quality of display image, the method of reduction, and the items of display. Incidentally, the print data as the basis of thumbnails varies in paper size (e.g., A3, A4, etc.) and resolution (e.g., 300 dpi, 600 dpi, etc.) depending on the content of each image. Therefore, reduction in the same ratio results in varies thumbnail size and resolution. Therefore, the system may be modified such that the thumbnail generator 105a adjusts the reduction ratio and resolution according to the user's instruction about the thumbnail size and resolution.

(13) Outline of the Function of the Third Embodiment (Regarding the Third Process)

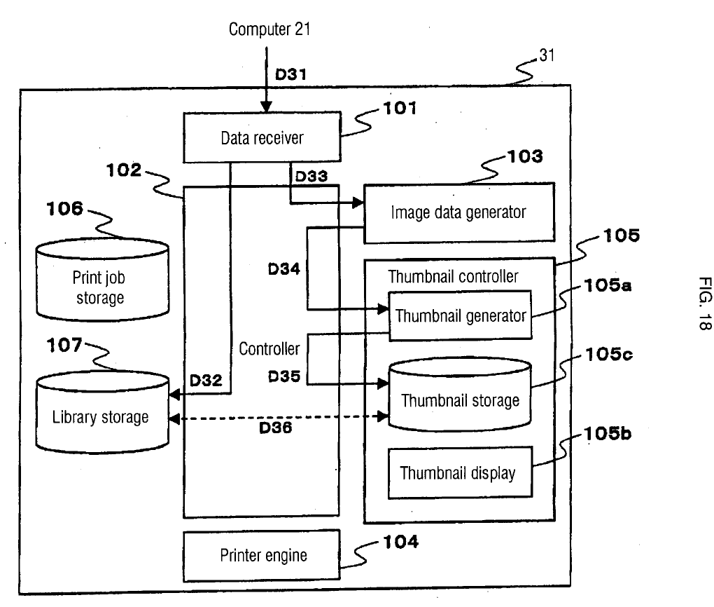

The following description is concerned with the process in which the printer 31 registers library when it receives a command to register library from the computer 21 connected through the network 41 and then generates thumbnails of library. FIG. 18 is a diagram showing the data flow in this process.

This process is basically the same as the abovementioned process in which the printer 31 registers print jobs when it receives a command to register print jobs from the computer 21 connected through the network 41 and then generates thumbnails of print jobs.

First, the data receiver 101 receives from the computer 21 a command for registration of library and print data relating to library for registration (D31).

The controller 102 registers the received print data in the library storage 107 (D32) and sends the print data to the image data generator 103 by the units of band (D33). The image data generator 103 generates, based on the print data, the image data by the units of band. Incidentally, the format for registration in the library storage 107 is not limited to the received print data but it may be the image data generated by the image data generator 103 or the format of intermediate code.

Next, the controller 102 sends the image data generated by the image data generator 103 to the thumbnail generator 105a by the units of band (D34).

The thumbnail generator 105a generates the thumbnail based on the image data and registers it in the thumbnail storage 105c (D35). At this point, the thumbnail to be registered is made to correspond to the print data registered in the library storage 107 (D36). In addition, the thumbnail storage 105c permits the registration of the data and time of registration, paper size, and other information relating to the library.

If the received object for registration is a print job for overlay of the form data stored in the library storage 107, the print job is registered according to the command for registration for the print data which is a combination of the print data relating to the overlay printing and the form data relating to the overlay printing stored in the library storage 107, and the thumbnails of the print job are generated.

(14) Outline of the Function of the Third Embodiment (Regarding the Fourth Process)

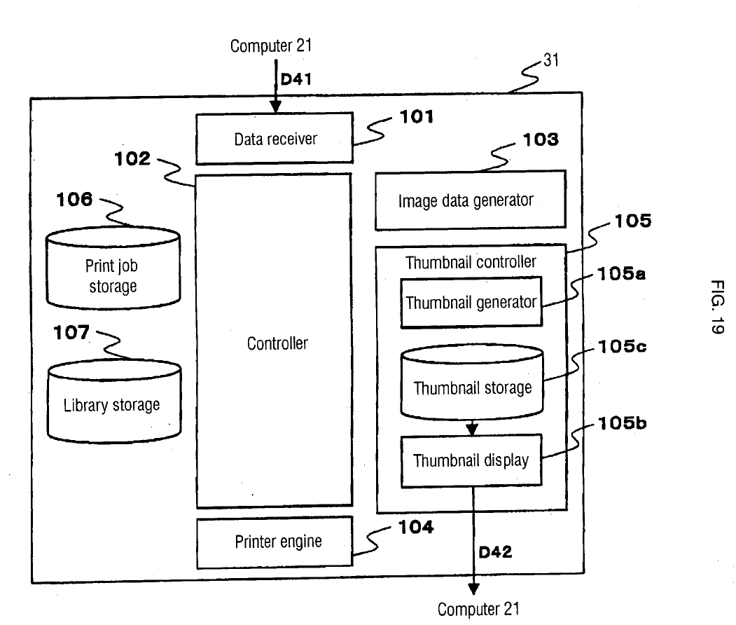

The following description is concerned with the process in which the printer 31 displays a list of thumbnails on the screen of the computer 21 as it receives a command to display thumbnails of the registered print jobs (including library) from the computer 21 connected through the network 41. FIG. 19 is a diagram showing the data flow in this process.

First, the data receiver 101 receives from the computer 21 a command for display of thumbnails (D41). The thumbnail display 105b generates the screen for list display by referencing the thumbnail stored in the thumbnail storage 105c, and sends it to the computer 21 (D42).

The screen for display of a list of thumbnails is generated in HTML file. This general-purpose file format permits the computer 21 to read the display of a list of thumbnails by using the general-purpose software such as Web browser.

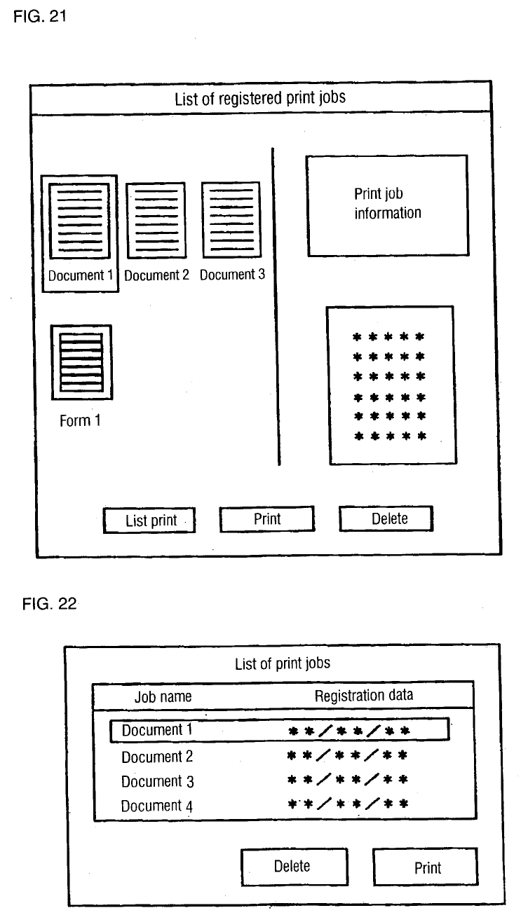

FIG. 21 is a diagram showing a list of thumbnails of registered print jobs which is displayed on the screen of the computer 21. What the user sees in this screen is the information (at the left side) about print jobs corresponding to the thumbnails selected in the screen and the enlarged thumbnail image (at the lower right side). The information includes the date and time of registration, file size, the number of pages, and paper size. The user clicks the “List print” button to print the screen of a list of thumbnails of the registered print jobs.

(15) Outline of the Function of the Third Embodiment (Regarding the Fifth Process)

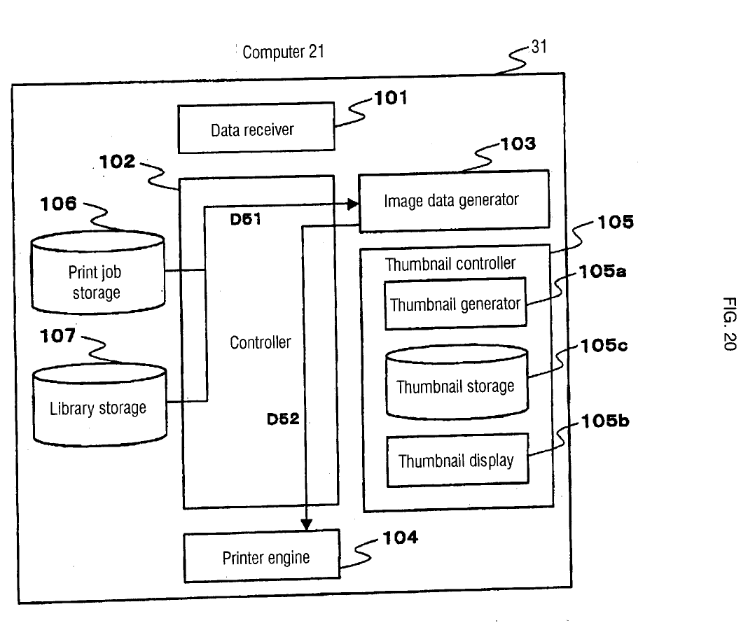

The following description is concerned with the process in which the printer 31 receives the specification of print jobs from the display of a list of thumbnails and then executes the printing. FIG. 20 is a diagram illustrating the data flow.

The user specifies the thumbnails in the screen (shown in FIG. 21) of a list of the registered print jobs and clicks the print button to print the print jobs corresponding to the specified thumbnails.

The controller 102 extracts the print jobs (which are made to correspond to the thumbnails specified on the screen) or the print data of library from the print job storage 106 or the library storage 107 and then send it to the image data generator 103 (D51). Thus, the image data generator 103 generates the image data based on the print data by the units of band. Then, the controller 102 sends the image data to the printer engine 104 by the units of band, and the printer engine 104 executes printing (D52).

We claim:

1. A printer designed to produce a printed matter in which image data of format pattern is superposed over print data generated according to the data generated by an application which is run by a computer connected thereto, wherein said printer comprises an input unit to enter said print data and image data from said computer connected thereto, a generating unit to generate prescribed related information data about said image data based on said image data entered, a storage unit to store said image data and said related information data generated while keeping their correspondence, an output unit to output to said computer said related information data stored in answer to a command for acquisition of said related information data of said computer, and a unit to acquire from said storage unit the image data specified by said print data entered and to print a printed matter in which said image data is superposed over said print data.

2. The printer as defined in claim 1, wherein said storage unit stores the data of said format pattern, which is generated as said computer executes said application, in such a way that the stored data can be read from said computer.

3. The printer as defined in claim 2, wherein said storage unit stores said application, which makes it possible to generate the data of said format pattern, in such a way that the application can be read from said computer.

4. The printer as defined in claim 1, wherein said output unit has a start signal input unit to enter the start signal which is output when the computer is turned on, and said output unit outputs to said computer the related information data stored in said storage unit when said start signal is entered by said start signal input unit.

5. The printer as defined in claim 1, wherein said output unit has an input unit to enter a signal demanding the acquisition of the related information data, which is output when said computer generates said print data, and said output unit outputs to said computer the related information data stored in said storage unit when said signal demanding the acquisition. of the related information data is entered by said signal input unit.

6. The printer as defined in claim 1, wherein said generating unit generates, according to said image data entered as said related information data, the data to display said image data in the form of reduced image.

7. The printer as defined in claim 1, wherein said generating unit generates, according to said image data entered as said related information data, the attribute information data of said image data.

8. The printer as defined in claim 1, wherein said generating unit notifies said computer about the generation of the related information data when it generates the related information data.

9. A printing method designed to produce a printed matter in which image data of format pattern is superposed over print data generated according to the data generated by an application which is run by a computer connected thereto, wherein said printing method comprises an input step to enter said print data and image data from said computer connected thereto, a generating step to generate prescribed related information data about said image data based on said image data entered, a storage step to store in a prescribed storage region said image data and said related information data generated while keeping their correspondence, an output step to output to said computer said related information data stored when said computer performs printing in which said image data is superposed over said print data, and a step to acquire from said storage region the image data specified by said print data entered and to print a printed matter in which said image data is superposed over said print data.

10. A medium recording a data generation/control program which is executed by a printer designed to produce a printed matter in which image data of format pattern is superposed over print data generated according to the data generated by an application which is run by a computer connected the printer, wherein said program comprises an input function to enter said print data and image data from said computer connected to the printer, a generating function to generate prescribed related information data about said image data based on said image data entered, a storage function to store in a prescribed storage region said image data and said related information data generated while keeping their correspondence, and an output function to output to said computer said related information data stored when said computer performs printing in which said image data is superposed over said print data.

11. A print controller which is connected to a printer to generate prescribed related information data about the image data of format pattern entered and which acquires from said printer said related information data about the image data of format pattern to be superposed over the print data generated and displays it, wherein said print controller comprises a generating unit to generate the print data based on the data generated by a prescribed application and to output it to said printer, a generating unit to generate the image data of format pattern to be superposed over the print data by a prescribed application, an image data output unit which outputs the image data generated to said printer and makes said printer generate said related information data about said image data and store it, an output unit to output to said printer connected a command to acquire said related information data which said printer has generated and stored, a storage unit to enter and store said related information data acquired, and a display unit to display the related information data stored.

12. The print controller as defined in claim 11, wherein said acquisition demand output unit notifies about the renewal of the related information data which is output from the printer connected and outputs to said printer the command for the acquisition of said related information data if said notification is entered.

13. A print controlling method for the print controller which is connected to a printer to generate prescribed related information data about the image data of format pattern entered and which acquires from said printer said related information data about the image data of format pattern to be superposed over the print data generated and displays it, wherein said print controlling method comprises a generating step to generate the print data based on the data generated by a prescribed application, a generating step to generate the image data of format pattern to be superposed over the print data by a prescribed application, an image data output step which outputs the image data generated to said printer and makes said printer generate said related information data about said image data and store it, an output step to output to said printer connected a command to acquire said related information data which said printer has generated and stored, a storage step to store said related information data acquired in a prescribed storage region, and a display unit to display the related information data stored.

14. A medium recording a print control program for the print controller which is connected to a printer to generate prescribed related information data about the image data of format pattern entered and which acquires from said printer said related information data about the image data of format pattern to be superposed over the print data generated and displays it, wherein said print control program comprises a generating function to generate the print data based on the data generated by a prescribed application, a generating step to generate the image data of format pattern to be superposed over the print data by a prescribed application, an image data output step which outputs the image data generated to said printer and makes said printer generate said related information data about said image data and store it, an output step to output to said printer connected a command to acquire said related information data which said printer has generated and stored, a storage step to store said related information data acquired in a prescribed storage region, and a display step to display the related information data stored.

15. A printing system composed of a printer, a server, and a plurality of clients connected together through a network capable of two-way communication, said printer producing a printed matter in which the image data of format pattern generated by said server is superposed over the print data generated by said each client, wherein said printing system is characterized in that said server has a generating unit to generate the image data of format pattern based on the data generated by execution of said application, and an image data output unit to output the image data thus generated to said printer, said each client has a print data generating unit to generate the print data based on the data generated by execution of a prescribed application, a print data output unit to output the thus generated print data to said printer, a related information data acquisition unit to acquire the prescribed related information data about the image data to be superposed over the print data which is stored in said printer, and a display unit to visibly display the thus acquired related information data, and said server has a data input unit to enter said image data which has been output by said server and the print data which has been output by said client, a related information data generating unit to generate the prescribed related information data about the thus entered image data, a related information data storage unit to store said image data and the generated related information data while keeping their correspondence, and a printing unit to acquire the image data specified by the entered print data from said storage unit and to produce a printed matter in which said image data is superposed over said print data.

16. The printing system as defined in claim 15, wherein said related information data storage unit stores the data about said format pattern, which is generated as said server executes said application, in such a way that the data can be read from the computer.

17. The printing system as defined in claim 15, wherein said related information data storage unit stores said application, which can generate the data of said format pattern, in such a way that said application can be read from said server.

18. A print system of the type having a print controller to output print data, an image generating unit to generate image data based on the print data received from said print controller, and a printer provided with a printing unit to perform printing based on the thus generated image data and a storage device, wherein said printer has a print data storage unit to store print data in said storage device, a thumbnail generating unit which, for print data stored in said storage device, generates thumbnails based on the image data generated by said image data generating unit and stores them in said storage device, and a thumbnail display unit which generates a list of thumbnails with reference to the thumbnails stored in said storage device and outputs it to said print controller, and said print controller displays the list of thumbnails received from said printer.

19. The print system as defined in claim 18, which further comprise a registered print data printing unit which, when notified by said print controller about the fact that a specific thumbnail has been specified in the screen of a list of said thumbnails, extracts the print data corresponding to the thumbnail from said storage device and performs printing based on the thus extracted print data.

20. The print system as defined in claim 18, wherein the image data generating unit of the printer generates the image data by the units of band based on the print data.

21. The print system as defined in claim 18, wherein the thumbnail generating unit of the printer divides the image data in band units into a plurality of blocks and generates the thumbnails by processing the blocks one by one, and the block has a size (corresponding to the band width) which can divide the band width.
